(19) United States
(12) Patent Application Publication
(10) Pub. No.: US 2015/0065243 A1
(43) Pub. Date: Mar. 5, 2015

(54) ZOOM CONTEXTUALS

(71) Applicant: Zynga Inc., San Francisco, CA (US)

(72) Inventors: Noah Mizrahi, Oakland, CA (US); Bradley Richard McKee, San Mateo, CA (US)

(21) Appl. No.: 14/471,384

(22) Filed: Aug. 28, 2014

Related U.S. Application Data
(60) Provisional application No. 61/871,633, filed on Aug. 29, 2013.

(51) Int. Cl. A63F 13/5258

(52) U.S. Cl. CPC A63F 13/5258
USPC 463/31

(57) ABSTRACT

A system, computer-readable storage medium storing at least one program, and a computer-implemented method for generating a virtual spatial environment comprising a first contextual for a first object and a second contextual for a second object. A zoom level of the virtual spatial environment is determined as exceeding a zoom threshold. A zoom contextual is generated based on an aggregation of the first contextual and the second contextual due at least to the zoom level exceeding the zoom threshold. A display of the first contextual and the second contextual in the virtual spatial environment is replaced with a display of the zoom contextual.

### CROSS-REFERENCE TO RELATED APPLICATIONS

This application claims the benefit of U.S. Provisional Application No. 61/871,633, filed Aug. 29, 2013, which is hereby incorporated herein by reference in its entirety.

### TECHNICAL FIELD

The subject matter disclosed herein generally relates to the processing of data. Specifically, the present disclosure addresses systems and methods to facilitate user interactions with a computer-implemented game.

### BACKGROUND

Many traditional online games may offer a user interface mechanics for performing game actions on selected game objects. For example, in a virtual farming game, a player may harvest a crop by selecting the individual crop and the selecting the type of game action that is to be performed on the selected individual crop. To harvest a second crop, the user may select the second crop and then select the appropriate game action for the second crop. This selection of a crop and then game action is repeated for each crop the user wishes to harvest.

### BRIEF DESCRIPTION OF THE DRAWINGS

The present disclosure is illustrated by way of example, and not limitation, in the figures of the accompanying drawings, in which like reference numerals indicate similar elements unless otherwise indicated.

FIG. 1 illustrates an example of a system for implementing various disclosed embodiments.

FIG. 2 illustrates an example social network, according to an example embodiment.

FIG. 3 is a block diagram illustrating example modules of a zoom contextual game system 300, according to an example embodiment.

FIG. 4 is a user interface diagram illustrating a game interface for a game executed by the zoom contextual game system of FIG. 3, according to an example embodiment.

FIG. 5 is a user interface diagram illustrating a user's interaction with the game interface, according to an example embodiment.

FIG. 6 is a flowchart of a method for generating a zoom contextual, according to an example embodiment.

FIG. 7 illustrates an example data flow in a system, according to an example embodiment.

FIG. 8 illustrates an example network environment, according to an example embodiment.

FIG. 9 illustrates an example computing system architecture, according to an example embodiment.

### DESCRIPTION OF EXAMPLE EMBODIMENTS

### Brief Overview

Example systems and methods of providing zoom contextuals are provided. In the following description, for purposes of explanation, numerous specific details are set forth in order to provide a thorough understanding of example embodiments. It will be evident, however, to one skilled in the art that the described systems and methods may be practiced without these specific details

A system, computer-readable storage medium storing at least one program, and a computer-implemented method for generating a virtual spatial environment comprising a first contextual for a first object and a second contextual for a second object. A zoom level of the virtual spatial environment is determined as exceeding a zoom threshold. A zoom contextual is generated based on an aggregation of the first contextual and the second contextual due at least to the zoom level exceeding the zoom threshold. A display of the first contextual and the second contextual in the virtual spatial environment is replaced with a display of the zoom contextual.

The systems and methods described herein may provide zoom contextuals. As used herein, a contextual may refer to a visual indication generated by a game system that provides state information regarding an interactive element of a game, such as a game object. To illustrate, some game systems may host a farming simulation game where a player interacts with various game objects, such as virtual animals, crops, buildings, avatars, and the like. One type of user interaction may be a harvest mechanic that can be initiated on these types game objects. By way of example and not limitation, a virtual animal may have a state model that determines when a player may harvest the virtual animal. For example, a virtual animal may begin in an initial “Hungry.” Upon being feed by the player, the game system may transition the state of the animal from the “Hungry” state to a “Waiting” state. The “Waiting” state may be associated with a timer that, when expires, cause the game system to transition the state of the virtual animal from the “Waiting” state to a “Ready” state. When a virtual animal is in a “Ready” state, the player may cause the game system to execute a harvest game mechanic on the virtual animal. Harvesting a virtual animal may cause the game system to award a game asset to the player, such as milk, wool, manure, any other suitable game asset that has value in the game.

In some embodiments, a game system may cause a game client to display a contextual or a “click to activate” to visually depict the state of the virtual game object or an available game action that may be applied to the virtual game object. For example, one game system implementing contextuals may cause a thought bubble to appear next to a virtual animal when that animal is in the “Hungry” state. Such contextual may be a comparatively convenient method for instructing the player as to what's the next step in the game with respect to the game object. Further, in some cases, clicking on the contextual may cause the game system to perform a game action represented by the contextual. For example, clicking on the thought bubble with an image of feed may cause the game system to perform a feeding game action on the virtual animal.

In some example embodiments, the game system may aggregate one or more contextuals into a single contextual based on the zoom level of a game. For example, a game may depict two or more virtual animals relatively near each other. For each of these virtual animals, the game system may generate a corresponding contextual to depict the state of the corresponding virtual animal. The game system may then detect that the user has zoomed out the display of the game. Responsive to detecting that the zoom level of the game camera exceeds a threshold zoom level, the game system may replace the separate contextuals of the two virtual animals with a single aggregated zoom contextual that corresponds to both virtual animals. A contextual that aggregates multiple contextuals into a single contextual based, at least in part on a zoom level, may be referred to as a zoom contextual. Further, in some cases, clicking on the zoom contextual may cause the game system to perform a game action for each game object represented by the contextual. For example, clicking on the thought bubble with an image of feed may cause the game system to perform a feeding game action on each virtual animal corresponding to the zoom contextual.

Zoom contextuals may provide any number of practical applications. For example, in the case of mobile devices, which may have comparatively limited screen sizes, a zoom contextual may provide a comparatively clean user interface for a user. Such may especially be the case in touch screens, as zooming out may increase the number of contextuals in the screen. However, replacing individual contextuals with zoom contextuals reduces the number of visual images that are displayed in a game. Reducing the number of visual images has a number of practical advantages. For example, it may reduce conflicts in user selection as it lessens the chance that selecting one game object may inadvertently be mistaken as a selection of another game object. These and other example embodiments may, in some cases, provide the technical improvement of reducing power consumption in that some embodiments may limit the frequency in which processing times of a touch screen are utilized. Such may be important for mobile devices, which may rely on batteries as a power source.

In various embodiments, a system, computer-readable storage medium storing at least one program, and a computer-implemented method can further provide for the following operations. A graphical user interface (GUI) is generated to include an interactive view that includes a visual representation of at least a part of a spatial environment within which a first object and a second object are located in spaced arrangement. The interactive view also includes respective visual representations of the first object and the second object.

A zoom level of the interactive view is determined to be below a zoom threshold. Based on the zoom level, the interactive view displays a first contextual associated with the first object and a second contextual associated with the second object. It is understood that, in various embodiments, the first and second contextuals are respectively configured to provide user input functionality for a corresponding object displayed in the interactive view. For example, the first contextual indicates a first action eligible to be performed on the first object by user interaction with the first contextual. The second contextual indicates a second action eligible to be performed on the second object by user interaction with the second contextual. In some embodiments, the first action and the second action are similar actions. In other embodiments, the first action and the second action are different actions.

A requested change in the zoom level of the interactive view is received. For example, a request for a change in the zoom level (“modified zoom level”) in order to zoom out of the part of the spatial environment currently displayed in the interactive view can be received. The modified zoom level is determined as exceeding the zoom threshold (such as a zoom-out threshold). In order to determine the modified zoom level exceeds the zoom threshold, a represented distance in the interactive view between the first and second objects is calculated at the modified zoom level. The represented distance between the first and second object is determined as being smaller than a predefined threshold distance. The represented distance between the first and second objects at the modified zoom level indicates that the first and second contextuals are to be aggregated in order generate a multi-object contextual representative of both the first and second actions.

Responsive to determining the modified zoom level exceeds the zoom threshold, the interactive view is updated in order to replace display of the first and second contextuals with a display of a multi-object contextual. Respective updated object display sizes for the first and second objects are calculated according to the modified zoom level. The interactive view is zoomed-out such that it is further updated to display also display an additional part of the spatial environment along with the first and second objects according to the respective updated object display sizes. The multi-object contextual is displayed in the zoomed-out interactive view proximate to both the first and second objects.

It is understood, that in various embodiments, the multi-object contextual is a user interface element configured to simultaneously indicate the first and second actions and to further provide user input functionality for both the first object and the second objects. Responsive to user-selection of the multi-object contextual in the interactive view, the first action is performed on the first object and the second action is performed on the on the second object.

These and other embodiments are described in greater below.

### Example System

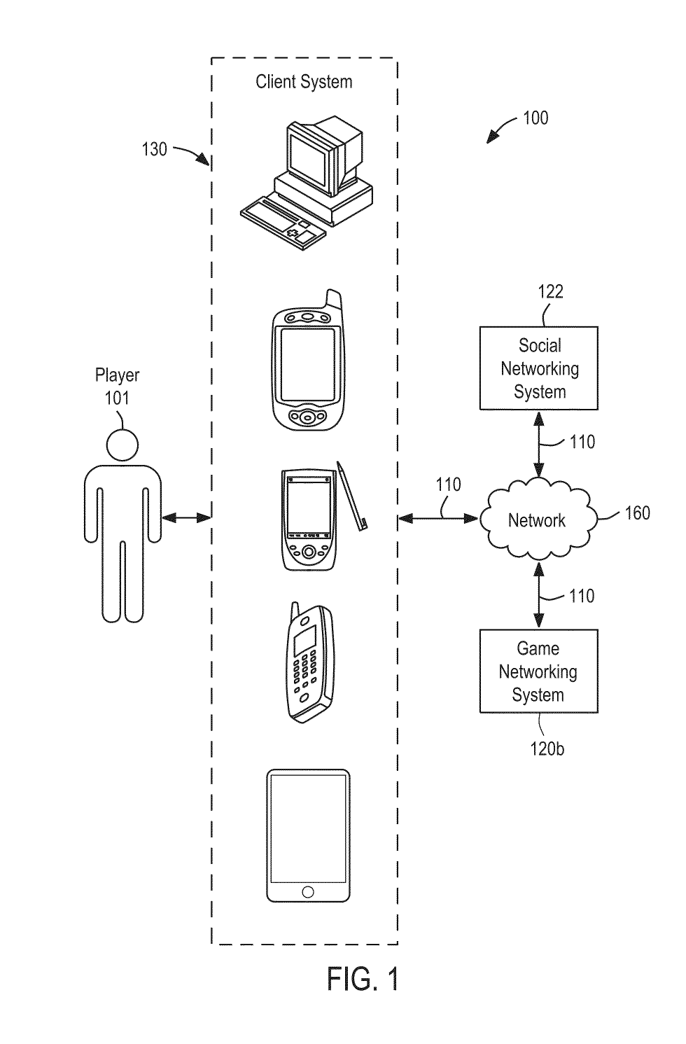

FIG. 1 illustrates an example of a system for implementing various disclosed embodiments. In particular embodiments, system 100 comprises player 101, social networking system 122, game networking system 120, client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 122 is a network-addressable computing system that can host one or more social graphs. Social networking system 122 can generate, store, receive, and transmit social networking data. Social networking system 122 can be accessed by the other components of system 100 either directly or via network 160. Game networking system 120 is a network-addressable computing system that can host one or more online games. Game networking system 120 can generate, store, receive, and transmit game-related data, such as, for example, game account data, game input, game state data, and game displays. Game networking system 120 can be accessed by the other components of system 100 either directly or via network 160. Player 101 may use client system 130 to access, send data to, and receive data from social networking system 122 and game networking system 120. Client system 130 can access social networking system 122 or game networking system 120 directly, via network 160, or via a third-party system. As an example and not by way of limitation, client system 130 may access game networking system 120 via social networking system 122. Client system 130 can be any suitable computing device, such as a personal computer, laptop, cellular phone, smart phone, computing tablet, and the like.

Although FIG. 1 illustrates a particular number of players 101, social networking systems 122, game networking systems 120, client systems 130, and networks 160, this disclosure contemplates any suitable number of players 101, social networking systems 122, game networking systems 120, client systems 130, and networks 160. As an example and not by way of limitation, system 100 may include one or more game networking systems 120 and no social networking systems 122. As another example and not by way of limitation, system 100 may include a system that comprises both social networking system 122 and game networking system 120. Moreover, although FIG. 1 illustrates a particular arrangement of player 101, social networking system 122, game networking system 120, client system 130, and network 160, this disclosure contemplates any suitable arrangement of player 101, social networking system 122, game networking system 120, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 122, game networking system 120, client system 130, and network 160, this disclosure contemplates any suitable connections between player 101, social networking system 122, game networking system 120, client system 130, and network 160. As an example and not by way of limitation, in particular embodiments, client system 130 may have a direct connection to social networking system 122 or game networking system 120, bypassing network 160.

### Online Games and Game Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120, which can be accessed using any suitable connection with a suitable client system 130. A player 101 may have a game account on game networking system 120, wherein the game account can contain a variety of information associated with the player 101 (e.g., the player's personal information, financial information, purchase history, player character state, game state). In some embodiments, the player 101 may play multiple games on game networking system 120, which may maintain a single game account for the player 101 with respect to all the games, or multiple individual game accounts for each game with respect to the player 101. In some embodiments, game networking system 120 can assign a unique identifier to each player 101 of an online game hosted on game networking system 120. Game networking system 120 can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 122, or game networking system 120). As an example and not by way of limitation, client system 130 can download client components of an online game, which are executed locally, while a remote game server, such as game networking system 120, provides backend support for the client components and may be responsible for maintaining application data of the game, processing the inputs from the player 101, updating and/or synchronizing the game state based on the game logic and each input from the player 101, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In particular embodiments, player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players 101. A game instance is associated with a specific player 101 when one or more game parameters of the game instance are associated with the specific player 101. As an example and not by way of limitation, a game instance associated with a first player 101 may be named “First Player's Play Area.” This game instance may be populated with the first player's PC and one or more in-game objects associated with the first player 101. In particular embodiments, a game instance associated with a specific player 101 may only be accessible by that specific player 101. As an example and not by way of limitation, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. As an example and not by way of limitation, a first player 101 may be associated with a first game instance, but the first game instance may be accessed by all first-degree friends in the first player's social network. In particular embodiments, the game engine may create a specific game instance for a specific player 101 when that player 101 accesses the game. As an example and not by way of limitation, the game engine may create a first game instance when a first player 101 initially accesses an online game, and that same game instance may be loaded each time the first player 101 accesses the game. As another example and not by way of limitation, the game engine may create a new game instance each time a first player 101 accesses an online game, wherein each game instance may be created randomly or selected from a set of predetermined game instances. In particular embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. As an example and not by way of limitation, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 122 or game networking system 120). In one embodiment, N. equals 1, such that the player's social network includes only first-degree friends. In another embodiment, Nₘₐₓ is unlimited and the player's social network is coextensive with the social graph.

In particular embodiments, the social graph is managed by game networking system 120, which is managed by the game operator. In other embodiments, the social graph is part of a social networking system 122 managed by a third-party (e.g., Facebook®, Friendster, Myspace). In yet other embodiments, player 101 has a social network on both game networking system 120 and social networking system 122, wherein player 101 can have a social network on the game networking system 120 that is a subset, superset, or independent of the player's social network on social networking system 122. In such combined systems, game network system 120 can maintain social graph information with edge type attributes that indicate whether a given friend is an “in-game friend,” an “out-of-game friend,” or both. The various embodiments disclosed herein are operable when the social graph is managed by social networking system 122, game networking system 120, or both.

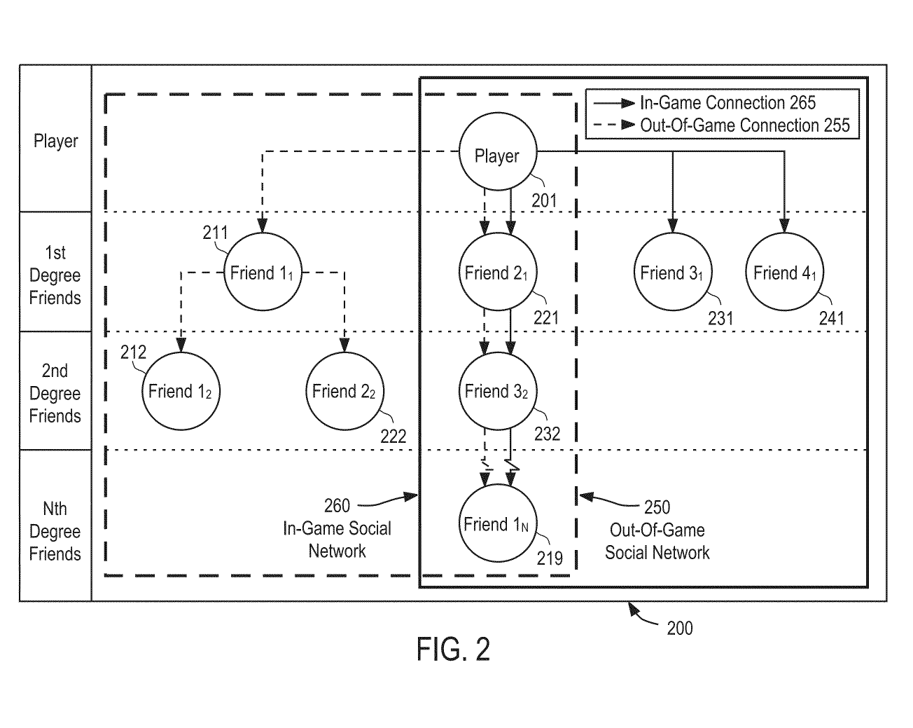

FIG. 2 shows an example of a social network within a social graph, according to an example embodiment. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 122.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Example Modules of a Game Engine Supporting Zoom Contextuals

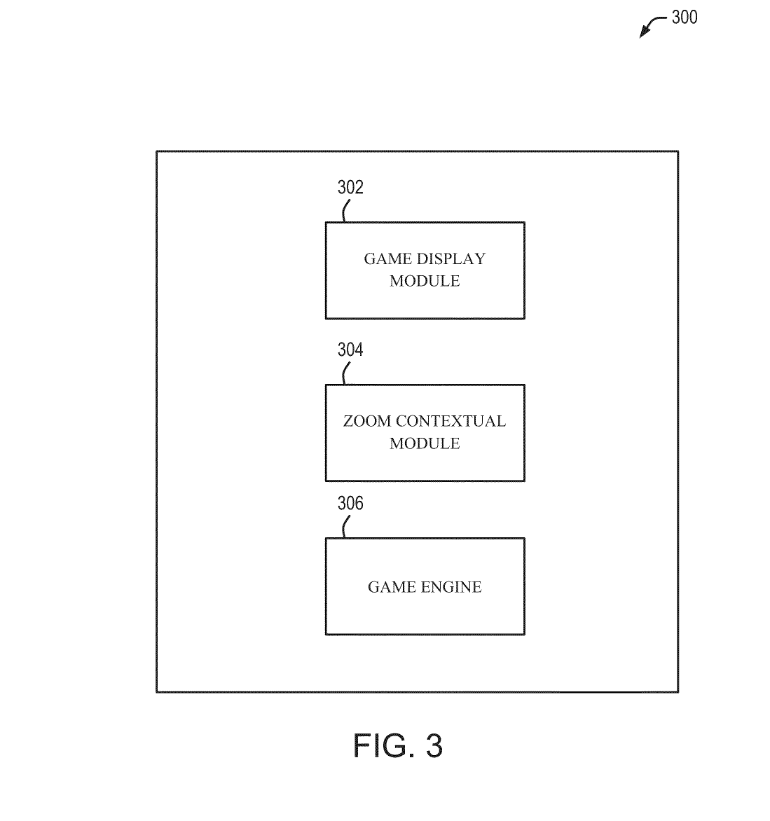

FIG. 3 is a block diagram illustrating example modules of a zoom contextual game system 300, according to an example embodiment. As described herein, the zoom contextual game system 300 facilitates aggregations of contextuals based on a zoom level. The zoom contextual game system 300 includes a game display module 302, a zoom contextual module 304, and a game engine 306.

The game display module 302 is a computer implemented system configured to generate display data for a game. Display data may refer to data or logic that can be used to generate the visual display of a game. In some embodiments, display data may specify one or more game objects to be displayed, the location or coordinates of those game objects, and any visual effects associated with those game objects.

The zoom contextual module 304 is a computer implemented system configured to generate contextuals for game objects. As described above, a contextual may refer to a visual indication of the state of game object. For example, the zoom contextual module 304 may generate a visual thought bubble depicting food for a cow that is in the “Hungry” state. The contextual module 304 may be configured to aggregate one or more contextuals based on the zoom level used to display a game.

The game engine 306 is a computer implemented module configured to process game logic and game data that express the game rules and logic of a game. For example, the game engine 308 may be configured to execute or simulate a game action on a game object, which may in turn involve updating the state of the game object or any other affected part of the game.

In some embodiment, the modules of the grouping game system 300 may be deployed as part of the game networking system 120 of FIG. 1, the client system 130 of FIG. 1, or some combination thereof.

Example User Interfaces for Zoom Contextuals

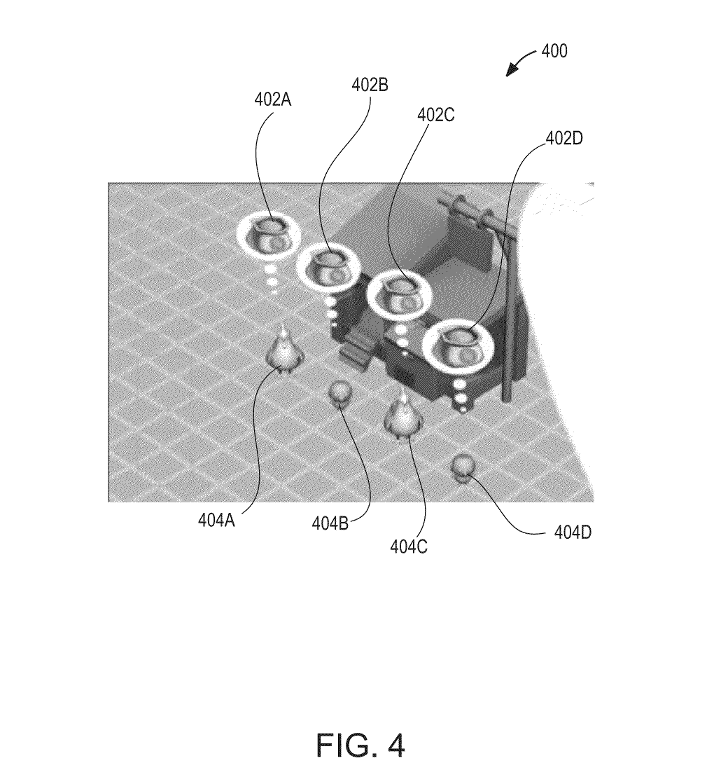

FIG. 4 is a user interface diagram illustrating a game interface 400 for a game executed by the zoom contextual game system 300 of FIG. 3, according to an example embodiment. As shown, the game interface 400 may display various game objects 404A-D in a virtual game environment representing a farm landscape. The various game objects 404A-D may be interactive elements in a game that each includes corresponding state data, which may, for example, characterize the corresponding game object's location, available game actions, a time until the next state change, current level, a status, and the like. The contextuals 402A-D may be user interactive game elements representing a game state for the corresponding game objects 402A-D. As shown in FIG. 4, each of the contextuals 402A-D signify a game action that may be performed on the corresponding the game object. To illustrate, a user selecting the contextual 402A may cause the zoom contextual module 304 to direct the game engine 306 to perform the harvest game action of the game object 404A. The game objects 404B-D may not be affected by the selection of the contextual 402A.

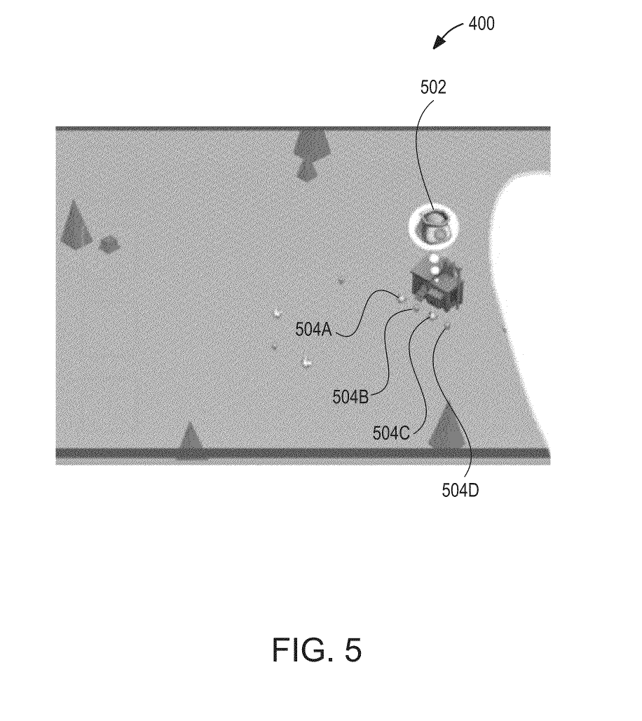

FIG. 5 is a user interface diagram illustrating a user's interaction with the game interface 500, according to an example embodiment. Compared to the game interface 400 shown in FIG. 4, the game interface 500 of FIG. 5 may depict the same virtual environment but zoomed out. As FIG. 5 shows, the game interface still includes the game objects 404A-D, albeit rendered from a further perspective. However, compared to FIG. 4, the game interface 500 now only includes a zoom contextual 502 rather than multiple contextuals 502A-D. Upon detection of a user selection of the zoom contextual may cause the zoom contextual module to direct the game engine 306 to perform the game action (e.g., harvest) associated with the zoom contextual on each of the game objects 304A-D.

### Example Methods for Game Object Grouping

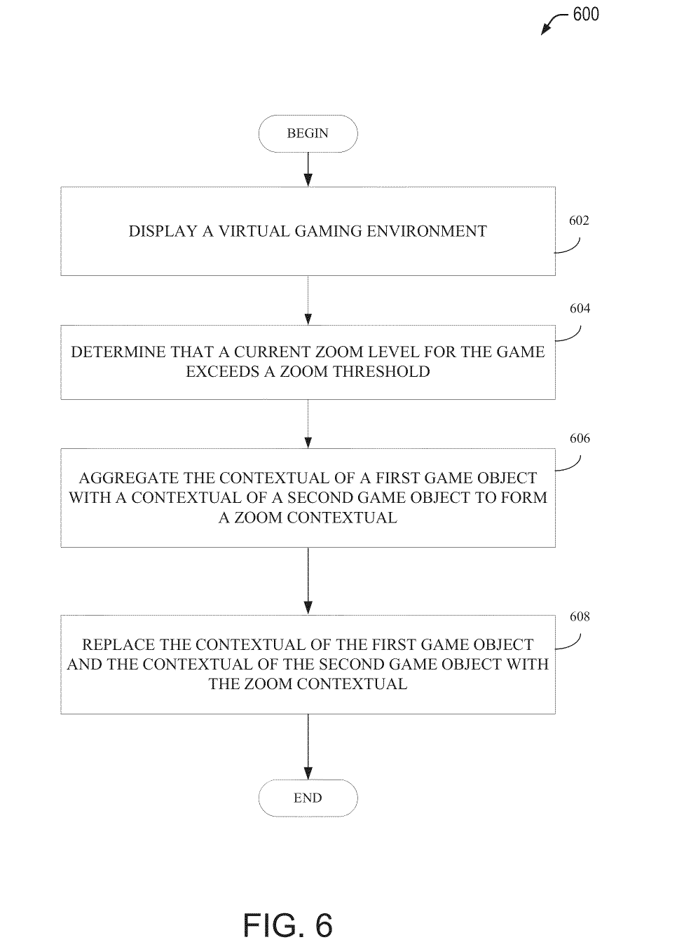

FIG. 6 is a flowchart of a method 600 for generating a zoom contextual, according to an example embodiment. In some embodiments, the method 600 is implemented by one or more processors, as may be executed by one or more modules shown in FIG. 3.

The method 600 begins, at operation 602, when the game display module 302 causes the client system 130 to display a virtual gaming environment for a game. In some cases, the game display module 302 may generate display data that characterizes a virtual environment including multiple game objects, where each of the multiple game objects are displayed with a corresponding contextual to provide a visual indication of the state of the game object.

Responsive to detecting a zoom action (e.g., a player zooming out a game camera for a game display), at operation 604, the zoom contextual module 304 may determine that a current zoom level for the game exceeds a zoom threshold.

At operation 606, the zoom contextual module 304 may then aggregate the contextual of a first game object with a contextual of a second game object to form a zoom contextual associated with both the first game object and the second game object. In some cases, the operation 606 may include selecting the first and second game objects based on a function that considers the distance between the game objects, the states of the game objects, available game actions, and the like.

At operation 608, the game engine 306 may cause the presentation module 302 to replace the contextual of the first game object and the contextual of the second game object with the zoom contextual. In this way, rather than displaying separate contextuals for each game objects, example embodiments may display a zoom contextual that relates to both the game objects. As discussed above, reducing the number of contextuals may increase the usability of the gaming interface when the reduction allows an increase in display area of the game environment and reduces the conflicts of user selections.

In some embodiments, the zoom contextual module 304 may select a zoom threshold that is dependent on the type or size of the client system 130. For example, the zoom contextual module 304 may bias the zoom threshold towards the maximum zoom out, while the zoom contextual module 304 may bias the zoom threshold towards the maximum zoom in. In some cases, such an adjustment may be made based on screen size data received from the SDK of the operating system executing on the client system 130. The screen size data may be the screen dimensions or may be inferred from a device identifier. In other embodiments, the zoom threshold may be set by a user preference specified in a game menu.

### Example Data Flow

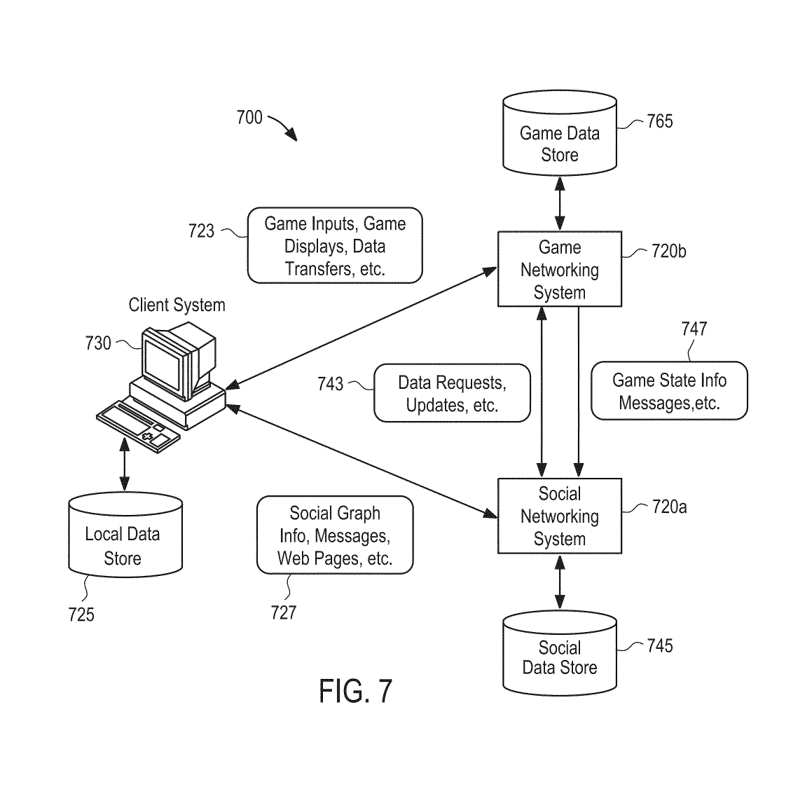

FIG. 7 illustrates an example data flow between the components of system 700. In particular embodiments, system 700 can include client system 730, social networking system 720a, and game networking system 720b. The components of system 700 can be connected to each other in any suitable configuration, using any suitable type of connection. The components may be connected directly or over any suitable network. Client system 730, social networking system 720a, and game networking system 720b can each have one or more corresponding data stores such as local data store 725, social data store 745, and game data store 765, respectively. Social networking system 720a and game networking system 720b can also have one or more servers that can communicate with client system 730 over an appropriate network. Social networking system 720a and game networking system 720b can have, for example, one or more internet servers for communicating with client system 730 via the Internet. Similarly, social networking system 720a and game networking system 720b can have one or more mobile servers for communicating with client system 730 via a mobile network (e.g., GSM, PCS, Wi-Fi, WPAN, and the like). In some embodiments, one server may be able to communicate with client system 730 over both the Internet and a mobile network. In other embodiments, separate servers can be used.

Client system 730 can receive and transmit data 723 to and from game networking system 720b. This data can include, for example, webpages, messages, game inputs, game displays, HTTP packets, data requests, transaction information, updates, and other suitable data. At some other time, or at the same time, game networking system 720b can communicate data 743, 747 (e.g., game state information, game system account information, page info, messages, data requests, updates, and so forth) with other networking systems, such as social networking system 720a (e.g., Facebook®, Myspace, and the like). Client system 730 can also receive and transmit data 727 to and from social networking system 720a. This data can include, for example, webpages, messages, social graph information, social network displays, HTTP packets, data requests, transaction information, updates, and other suitable data.

Communication between client system 730, social networking system 720a, and game networking system 720b can occur over any appropriate electronic communication medium or network using any suitable communications protocols. For example, client system 730, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 720b, the BLOB containing the game state for the instance corresponding to the player can be transmitted to client system 730 for use by a client-side executed object to process. In particular embodiments, the client-side executable may be a FLASH-based game, which can de-serialize the game state data in the BLOB. As a player plays the game, the game logic implemented at client system 730 maintains and modifies the various game state parameters locally. The client-side game logic may also batch game events, such as mouse clicks, and transmit these events to game networking system 720b. Game networking system 720b may itself operate by retrieving a copy of the BLOB from a database or an intermediate memory cache (memcache) layer. Game networking system 720b can also de-serialize the BLOB to resolve the game state parameters and execute its own game logic based on the events in the batch file of events transmitted by the client to synchronize the game state on the server side. Game networking system 720b may then re-serialize the game state, now modified, into a BLOB and pass this to a memory cache layer for lazy updates to a persistent database.

With a client-server environment in which the online games may run, one server system, such as game networking system 720b, may support multiple client systems 730. At any given time, there may be multiple players at multiple client systems 730, all playing the same online game. In practice, the number of players playing the same game at the same time may be very large. As the game progresses with each player, multiple players may provide different inputs to the online game at their respective client systems 730, and multiple client systems 730 may transmit multiple player inputs and/or game events to game networking system 720b for further processing. In addition, multiple client systems 730 may transmit other types of application data to game networking system 720b.

In particular embodiments, a computer-implemented game may be a text-based or turn-based game implemented as a series of web pages that are generated after a player selects one or more actions to perform. The web pages may be displayed in a browser client executed on client system 730. As an example and not by way of limitation, a client application downloaded to client system 730 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 720a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 730, either caused by an action of a game player or by the game logic itself, client system 730 may need to inform game networking system 720b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 700 is discussed in reference to updating a multi-player online game hosted on a network-addressable system (such as, for example, social networking system 720a or game networking system 720b), where an instance of the online game is executed remotely on a client system 730, which then transmits application event data to the hosting system such that the remote game server synchronizes game state associated with the instance executed by the client system 730.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 730 may include a Flash client. The Flash client may be configured to receive and run Flash application or game object code from any suitable networking system (such as, for example, social networking system 720a or game networking system 720b). In particular embodiments, the Flash client may be run in a browser client executed on client system 730. A player can interact with Flash objects using client system 730 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 730, the Flash client may send the events that caused the game state changes to the in-game object to game networking system 720b. However, to expedite the processing and hence the speed of the overall gaming experience, the Flash client may collect a batch of some number of events or updates into a batch file. The number of events or updates may be determined by the Flash client dynamically or determined by game networking system 720b based on server loads or other factors. For example, client system 730 may send a batch file to game networking system 720b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 730. In particular embodiments, the batch file may be a text file and the name-value pairs may be in string format.

In particular embodiments, when a player plays an online game on client system 730, game networking system 720b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 720b may retrieve the corresponding BLOB from the database to determine the most-recent values of the game-related data. In particular embodiments, while a player is playing the online game, game networking system 720b may also load the corresponding BLOB into a memory cache so that the game system may have faster access to the BLOB and the game-related data contained therein.

### Example Network Systems

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

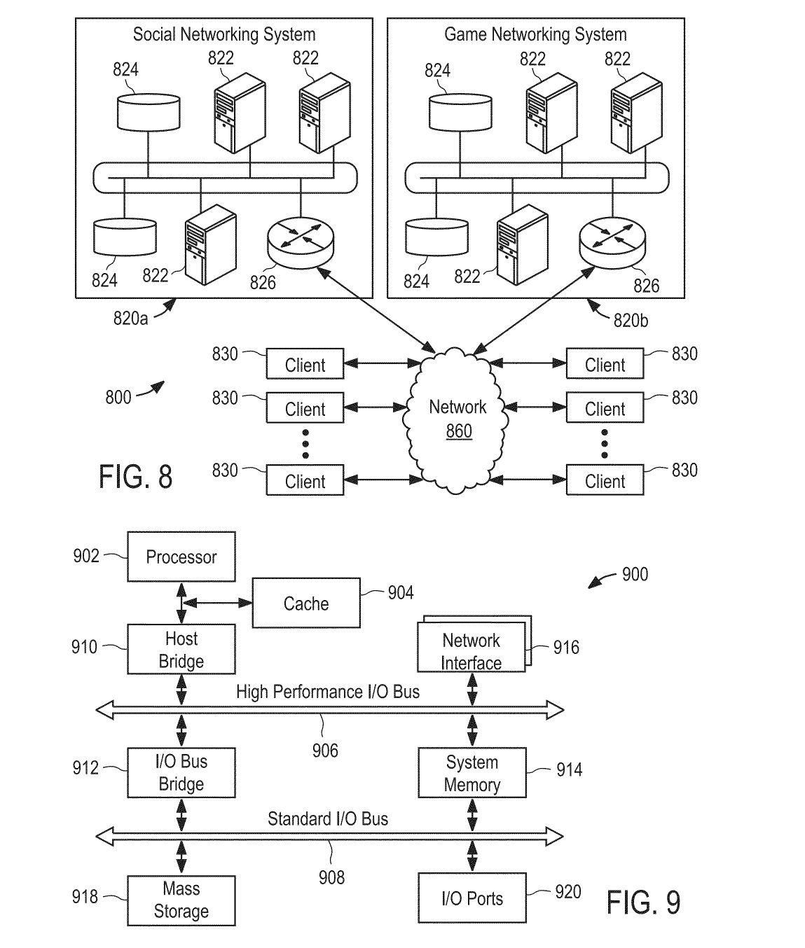

Particular embodiments may operate in a wide area network environment, such as the Internet, including multiple network addressable systems. FIG. 8 illustrates an example network environment, in which various example embodiments may operate. Network cloud 860 generally represents one or more interconnected networks, over which the systems and hosts described herein can communicate. Network cloud 860 may include packet-based wide area networks (such as the Internet), private networks, wireless networks, satellite networks, cellular networks, paging networks, and the like. As FIG. 8 illustrates, particular embodiments may operate in a network environment comprising one or more networking systems, such as social networking system 820a, game networking system 820b, and one or more client systems 830. The components of social networking system 820a and game networking system 820b operate analogously; as such, hereinafter they may be referred to simply at networking system 820. Client systems 830 are operably connected to the network environment via a network service provider, a wireless carrier, or any other suitable means.

Networking system 820 is a network addressable system that, in various example embodiments, comprises one or more physical servers 822 and data stores 824. The one or more physical servers 822 are operably connected to computer network 860 via, by way of example, a set of routers and/or networking switches 826. In an example embodiment, the functionality hosted by the one or more physical servers 822 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 822 may host functionality directed to the operations of networking system 820. Hereinafter servers 822 may be referred to as server 822, although server 822 may include numerous servers hosting, for example, networking system 820, as well as other content distribution servers, data stores, and databases. Data store 824 may store content and data relating to, and enabling, operation of networking system 820 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 824 corresponds to one or more of a variety of separate and integrated databases, such as relational databases and object-oriented databases, that maintain information as an integrated collection of logically related records or files stored on one or more physical systems. Structurally, data store 824 may generally include one or more of a large class of data storage and management systems. In particular embodiments, data store 824 may be implemented by any suitable physical system(s) including components, such as one or more database servers, mass storage media, media library systems, storage area networks, data storage clouds, and the like. In one example embodiment, data store 824 includes one or more servers, databases (e.g., MySQL), and/or data warehouses. Data store 824 may include data associated with different networking system 820 users and/or client systems 830.

Client system 830 is generally a computer or computing device including functionality for communicating (e.g., remotely) over a computer network. Client system 830 may be a desktop computer, laptop computer, personal digital assistant (PDA), in- or out-of-car navigation system, smart phone or other cellular or mobile phone, or mobile gaming device, among other suitable computing devices. Client system 830 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 830 to enter addresses of specific network resources to be retrieved, such as resources hosted by networking system 820. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 830 desires to view a particular webpage (hereinafter also referred to as a target structured document) hosted by networking system 820, the user's web browser, or other document rendering engine or suitable client application, formulates and transmits a request to networking system 820. The request generally includes a URL or other document identifier as well as metadata or other information. By way of example, the request may include information identifying the user, such as a user ID, as well as information identifying or characterizing the web browser or operating system running on the user's client computing device 830. The request may also include location information identifying a geographic location of the user's client system or a logical network location of the user's client system. The request may also include a timestamp identifying when the request was transmitted.

Although the example network environment described above and illustrated in FIG. 8 is described with respect to social networking system 820a and game networking system 820b, this disclosure encompasses any suitable network environment using any suitable systems. As an example and not by way of limitation, the network environment may include online media systems, online reviewing systems, online search engines, online advertising systems, or any combination of two or more such systems.

### Example Computer System

FIG. 9 illustrates an example computing system architecture, which may be used to implement a server 822 or a client system 830. In one embodiment, a hardware system 900 comprises a processor 902, a cache memory 904, and one or more executable modules and drivers, stored on a tangible computer readable medium, directed to the functions described herein. Additionally, hardware system 900 may include a high performance input/output (I/O) bus 906 and a standard I/O bus 908. A host bridge 910 may couple processor 902 to high performance I/O bus 906, whereas I/O bus bridge 912 couples the two buses 906 and 908 to each other. A system memory 914 and one or more network/communication interfaces 916 may couple to bus 906. Hardware system 900 may further include video memory (not shown) and a display device coupled to the video memory. Mass storage 918 and I/O ports 920 may couple to bus 908. Hardware system 900 may optionally include a keyboard, a pointing device, and a display device (not shown) coupled to bus 908. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 900 are described in greater detail below. In particular, network interface 916 provides communication between hardware system 900 and any of a wide range of networks, such as an Ethernet (e.g., IEEE 802.3) network, a backplane, and so forth. Mass storage 918 provides permanent storage for the data and programming instructions to perform the above-described functions implemented in servers 822, whereas system memory 914 (e.g., DRAM) provides temporary storage for the data and programming instructions when executed by processor 902. I/O ports 920 are one or more serial and/or parallel communication ports that provide communication between additional peripheral devices, which may be coupled to hardware system 900.

Hardware system 900 may include a variety of system architectures and various components of hardware system 900 may be rearranged. For example, cache 904 may be on-chip with processor 902. Alternatively, cache 904 and processor 902 may be packed together as a “processor module,” with processor 902 being referred to as the “processor core.” Furthermore, certain embodiments of the present disclosure may not require nor include all of the above components. For example, the peripheral devices shown coupled to standard I/O bus 908 may couple to high performance I/O bus 906. In addition, in some embodiments, only a single bus may exist, with the components of hardware system 900 being coupled to the single bus. Furthermore, hardware system 900 may include additional components, such as additional processors, storage devices, or memories.

An operating system manages and controls the operation of hardware system 900, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
generating a virtual spatial environment comprising a first contextual for a first object and a second contextual for a second object;
determining a zoom level of the virtual spatial environment exceeds a zoom threshold;
in an automated operation using one or more processors, generating a zoom contextual based on an aggregation of the first contextual and the second contextual due at least to the zoom level exceeding the zoom threshold; and
replacing a display of the first contextual and the second contextual in the virtual spatial environment with a display of the zoom contextual.

2. The computer-implemented method of claim 1, wherein generating a zoom contextual based on an aggregation of the first contextual and the second contextual comprises:
aggregating the first contextual and the second contextual based on the first object being within a threshold distance from the second object in the virtual spatial environment.

3. The computer-implemented method of claim 1, further comprising:
wherein the first contextual indicates a first action eligible to be performed on the first object; and
wherein the second contextual indicates a second action eligible to be performed on the second object.

4. The computer-implemented method of claim 3, wherein generating a zoom contextual based on an aggregation of the first contextual and the second contextual comprises:
generating the zoom contextual to indicate the first action and the second action; and
responsive to receipt of a selection of the zoom contextual:
performing the first action on the first object; and
performing the second action on the second object.

5. The computer-implemented method of claim 3, further comprising:
responsive to receipt of a selection of the first contextual, performing the first action on the first object; and
responsive to receipt of a selection of the second contextual, performing the second action on the second object.

6. The computer-implemented method of claim 1, further comprising:
receiving at least one zoom action indicating a desired zoom level;
wherein determining a current zoom level of the virtual spatial environment exceeds a zoom threshold comprises: determining the desired zoom level exceeds the zoom threshold;
calculating a first modified display size of the first object according to the desired zoom level;
calculating a second modified display size of the second object according to the desired zoom level;
updating a display of the first object in the virtual spatial environment according to the first modified display size; and
updating a display of the second object in the virtual spatial environment according to the second modified display size.

7. The computer-implemented method of claim 1, wherein determining a zoom level of the virtual spatial environment exceeds a zoom threshold comprises:
determining a display area size of a user device currently displaying the virtual spatial environment; and
identifying the zoom threshold based on the display area size of the user device.

8. A machine-readable storage medium storing instructions which, when executed by one or more processors, cause the one or more processors to perform operations comprising:
generating a virtual spatial environment comprising a first contextual for a first object and a second contextual for a second object;
determining a zoom level of the virtual spatial environment exceeds a zoom threshold;
generating a zoom contextual based on an aggregation of the first contextual and the second contextual due at least to the zoom level exceeding the zoom threshold; and
replacing a display of the first contextual and the second contextual in the virtual spatial environment with a display of the zoom contextual.

9. The machine-readable storage medium of claim 8, wherein generating a zoom contextual based on an aggregation of the first contextual and the second contextual comprises:
aggregating the first contextual and the second contextual based on the first object being within a threshold distance from the second object in the virtual spatial environment.

10. The machine-readable storage medium of claim 8, further comprising:
wherein the first contextual indicates a first action eligible to be performed on the first object; and
wherein the second contextual indicates a second action eligible to be performed on the second object.

11. The machine-readable storage medium of claim 10, wherein generating a zoom contextual based on an aggregation of the first contextual and the second contextual comprises:
generating the zoom contextual to indicate the first action and the second action; and
responsive to receipt of a selection of the zoom contextual:
performing the first action on the first object; and
performing the second action on the second object.

12. The machine-readable storage medium of claim 10, further comprising:
responsive to receipt of a selection of the first contextual, performing the first action on the first object; and
responsive to receipt of a selection of the second contextual, performing the second action on the second object.

13. The machine-readable storage medium of claim 8, further comprising:
receiving at least one zoom action indicating a desired zoom level;
wherein determining a current zoom level of the virtual spatial environment exceeds a zoom threshold comprises: determining the desired zoom level exceeds the zoom threshold;
calculating a first modified display size of the first object according to the desired zoom level;
calculating a second modified display size of the second object according to the desired zoom level;
updating a display of the first object in the virtual spatial environment according to the first modified display size; and
updating a display of the second object in the virtual spatial environment according to the second modified display size.

14. The machine-readable storage medium of claim 8, wherein determining a zoom level of the virtual spatial environment exceeds a zoom threshold comprises:
determining a display area size of a user device currently displaying the virtual spatial environment; and
identifying the zoom threshold based on the display area size of the user device.

15. A computer system comprising:
a processor;
a memory device holding an instruction set executable on the processor to cause the computer system to perform the operations comprising:
generating a virtual spatial environment comprising a first contextual for a first object and a second contextual for a second object;
determining a zoom level of the virtual spatial environment exceeds a zoom threshold;
generating a zoom contextual based on an aggregation of the first contextual and the second contextual due at least to the zoom level exceeding the zoom threshold; and
replacing a display of the first contextual and the second contextual in the virtual spatial environment with a display of the zoom contextual.

16. A computer-implemented method, comprising:
generating a graphical user interface (GUI) that includes an interactive view comprising a visual representation of at least a part of a spatial environment within which a first object and a second object are located in spaced arrangement, and respective visual representations of the first object and the second object;
in response to determining that a zoom level of the interactive view is below a zoom threshold, causing display in the interactive view of a first contextual proximate to the first object and a second contextual proximate to the second object, wherein the first and second contextuals each comprise a user interface (UI) element configured to provide respective user input functionality for the first and second objects;
modifying the zoom level of the interactive view;
determining the modified zoom level exceeds the zoom threshold; and
in an automated operation performed by one or more processors in response to determining the modified zoom level exceeds the zoom threshold, causing display within the interactive view of a multi-object contextual in replacement of display of the first and second contextuals, wherein the multi-object contextual comprises a UI element configured to provide user input functionality for both the first object and the second object.

17. The computer-implemented method of claim 16, wherein the determining that the modified zoom level exceeds the zoom threshold comprises:
calculating a represented distance in the interactive view between the first and second objects at the modified zoom level; and
determining that the represented distance between the first and second object is smaller than a predefined threshold distance.

18. The computer-implemented method of claim 16, wherein:
the first contextual indicates a first action eligible to be performed on the first object by user interaction with the first contextual; and
the second contextual indicates a second action eligible to be performed on the second object by user interaction with the second contextual, wherein the first and second action comprise a same action.

19. The computer-implemented method of claim 18, wherein causing display of the multi-object comprises configuring the multi-object contextual to concurrently indicate both the first action and the second action; and
responsive to user-selection of the multi-object contextual:
performing the first action on the first object; and
performing the second action on the second object.

20. The computer-implemented method of claim 18, further comprising:
responsive to user-selection of the first contextual, performing the first action on the first object; and
responsive to user-selection of the second contextual, performing the second action on the second object.
